(19) United States
(12) Patent Application Publication
(10) Pub. No.: US 2017/0031809 A1
(43) Pub. Date: Feb. 2, 2017

(54) NON-TRANSITORY COMPUTER-READABLE STORAGE MEDIUM, INFORMATION CONTROLLER, AND INFORMATION CONTROL METHOD

(71) Applicant: FUJITSU LIMITED, Kawasaki-shi (JP)

(72) Inventors: Atsuji SEKIGUCHI, Kawasaki (JP); Yuuji HOTTA, Kawasaki (JP); Toshihiro SHIMIZU, Sagamihara (JP); Takeshi Yasuie, Kawasaki (JP)

(73) Assignee: FUJITSU LIMITED, Kawasaki-shi (JP)

(21) Appl. No.: 15/219,561

(22) Filed: Jul. 26, 2016

(30) Foreign Application Priority Data
Jul. 30, 2015 (JP) 2015-150465

(51) Int. Cl. G06F 11/36

(52) U.S. Cl. CPC G06F 11/3692; G06F 11/3684; G06F 11/3688

(57) ABSTRACT

A non-transitory computer-readable storage medium storing an information control program that causes a computer to execute a process including receiving an update request for updating first information stored in a first storage area, the update request corresponding to a selected application, and when the selected application is a first application having been available later than a second application that is configured to update the first information stored in a first storage area, updating second information based on the update request for updating the first information, the second information being information corresponding to a part of the first information and being stored in a second storage area different from the first storage area.

### CROSS-REFERENCE TO RELATED APPLICATIONS

This application is based upon and claims the benefit of priority of the prior Japanese Patent Application No. 2015-150465, filed on Jul. 30, 2015, the entire contents of which are incorporated herein by reference.

### FIELD

The embodiments discussed herein are related to a non-transitory computer-readable storage medium, an information controller, and an information control method.

### BACKGROUND

A business operator providing services to users (hereinafter simply referred to as a business operator) builds a business system for providing the services for the users (hereinafter simply referred to as a business system), for example. Then, the business operator applies a security patch, introduces a new function to the business system in operation, or does other activities, as appropriate. Specifically, the business operator applies the security patch, introduces the new function, or does other activities by, for example, releasing a new program to the business system.

Here, an unknown bug may be included in the program released to the business system. Then, if there is any unknown bug in the released program, it is likely that information is updated in any way unintended by the business operator (which is hereinafter referred to as destruction of information). Thus, the business operator takes an action that limits an extent to which the destruction of information occurs, for example, for a case where any unknown bug is included in the released program.

Canary release is known as a release method for limiting an extent to which the destruction of Information involved in a program release occurs. The canary release is a release method that makes a new function implemented by a released program available only to some of users as a trial basis and checks whether or not any unknown bug is included in the released program. Then, if it is judged that no unknown bug is included in the released program, the canary release method makes the new function implemented by the released program available to all users.

Accordingly, when performing the canary release, the business operator releases a program such that a new function implemented by the released program and an existing function that is already running on the business system (function corresponding to the older version of the new function) operate simultaneously. Then, in this case, the business operator sets the business system such that each user uses only either one of the existing function and the new function. Furthermore, in this case, the business operator separates the information accessed only by the new function from the information accessed by the existing function (the information only accessed by the new function is hereinafter referred to as separated information and the information accessed by the existing function is referred to as stored information).

This allows the business operator to limit the impact of any unknown bug only to the separated information even when the destruction of information occurs due to the unknown bug included in the released program. Thus, performing the canary release makes it possible for the business operator to control the impact on the business system caused when the unknown bug is included in the released program.

### SUMMARY

According to an aspect of the invention, A non-transitory computer-readable storage medium storing an Information control program that causes a computer to execute a process including receiving an update request for updating first information stored in a first storage area, the update request corresponding to a selected application, and when the selected application is a first application having been available later than a second application that is configured to update the first information stored in a first storage area, updating second information based on the update request for updating the first information, the second information being information corresponding to a part of the first information and being stored in a second storage area different from the first storage area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overall configuration of an information processing system;

FIG. 2 is a diagram illustrating a specific example of an Information processor when canary release is performed;

FIGS. 3A and 3B are diagrams illustrating a specific example of the information processor when the canary release is performed;

FIG. 4 is a diagram illustrating a specific example of the Information processor when the canary release is performed;

FIG. 5 is a diagram outlining information control processing in a first embodiment;

FIG. 6 is a diagram illustrating a hardware configuration of the information processor;

FIG. 7 is a block diagram of each function of the Information processor;

FIG. 8 is a block diagram of information stored in an information storage area of the information processor;

FIG. 9 is a flow chart outlining the information control processing in the first embodiment;

FIG. 10 is a flow chart outlining the information control processing in the first embodiment;

FIG. 11 is a diagram outlining the information control processing in the first embodiment;

FIG. 12 is a flow chart illustrating details of the information control processing in the first embodiment;

FIG. 13 is a flow chart illustrating details of the information control processing in the first embodiment;

FIG. 14 is a flow chart illustrating details of the information control processing in the first embodiment;

FIG. 15 is a flow chart illustrating details of the information control processing in the first embodiment;

FIG. 16 is a flow chart illustrating details of the information control processing in the first embodiment;

FIG. 17 is a diagram illustrating a specific example of stored information;

FIG. 18 is a diagram illustrating the stored information after processing of S54 is executed;

FIG. 19 is a diagram illustrating difference information created in processing of S55;

FIG. 20 is a diagram illustrating a specific example of management information created in processing of S56;

FIG. 21 is a diagram illustrating a specific example of the difference information after processing of S32 is executed;

FIG. 22 is a diagram illustrating a specific example of the difference information after the processing of S32 is executed;

FIG. 23 is a diagram illustrating a specific example of the stored information after processing of S41 is executed;

FIG. 24 is a diagram illustrating a specific example of the difference information after processing of S42 is executed;

FIG. 25 is a diagram illustrating a specific example of the management information after processing of S43 is executed;

FIG. 26 illustrates a specific example of the stored information before processing of S62 is executed;

FIG. 27 illustrates a specific example of the difference information before the processing of S62 is executed;

FIG. 28 illustrates a specific example of the stored information after the processing of S62 is executed;

FIG. 29 is a flow chart illustrating information control processing in a second embodiment;

FIG. 30 is a flow chart illustrating the information control processing in the second embodiment;

FIG. 31 is a flow chart illustrating the information control processing in the second embodiment;

FIG. 32 is a diagram illustrating a specific example of second difference information;

FIG. 33 is a diagram illustrating a specific example of the stored information after processing of S92 is executed; and

FIG. 34 is a diagram illustrating a specific example of the stored information having information about a number corresponding to a value indicated by a stored number.

### DESCRIPTION OF EMBODIMENTS

In general, when releasing a program, a business operator releases a next program after a certain period of time elapses. More specifically, the business operator does not make a next release on a business system until a new function by a released program is used to some extent by users, and the business operator is able to judge whether or not destruction of information due to the released program occurs.

This allows the business operator to avoid occurrence of a situation in which it is not possible for the business operator to identify a program that causes destruction of information since more than one program release is made concurrently, when the destruction of information due to the released program occurs. Accordingly, in this case, it is possible for the business operator to promptly identify a cause of the occurred destruction of information.

Here, in the case of the canary release as described above, users who use a new function by a released program are limited. Thus, when the canary release is performed, time till the new function by the released program is used to some extent and judgment is possible on whether or not destruction information involved in a program release occurs is longer than a normal release. Therefore, when performing the canary release, the business operator has to set an interval of program releases longer than when performing a normal release.

In addition, even if separated information and stored information are managed separately as described above, a new function may access the stored information depending on content of processing of the new function by the released program. Thus, it is not possible for the business operator to limit the impact due to any unknown bug only to the separated information.

Now, one aspect aims to provide an information control program, an information controller, and an information control method that limit the impact of a program bug and shorten an interval of program releases.

Embodiments are described hereinafter with reference to the drawings.

[Configuration of an Information Processing System]

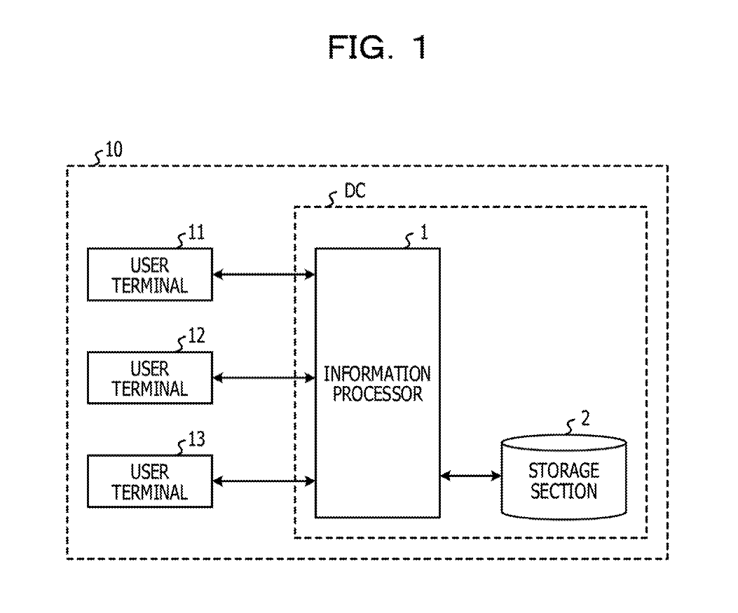

FIG. 1 is a diagram illustrating an overall configuration of an information processing system 10. In the information processing system 10 illustrated in FIG. 1, an Information processor 1 (hereinafter also referred to as an information controller 1) is provided in a data center DC. In the information processor 1 illustrated in FIG. 1, for example, a business system for providing users with services is built. In addition, in an example illustrated in FIG. 1, the information processor 1 has a storage section 2.

User terminals 11, 12, and 13 are capable of accessing the data center DC by way of a network such as the Internet or an intranet, or the like, for example.

In response to receipt of a processing request transmitted from the user terminals 11, 12, or 13, the information processor 1 executes processing on information stored in the storage section 2, for example. Specifically, the information processor 1, for example, updates or reads the information stored in the storage section 2.

[A Specific Example of an Information Processor when Canary Release is Performed]

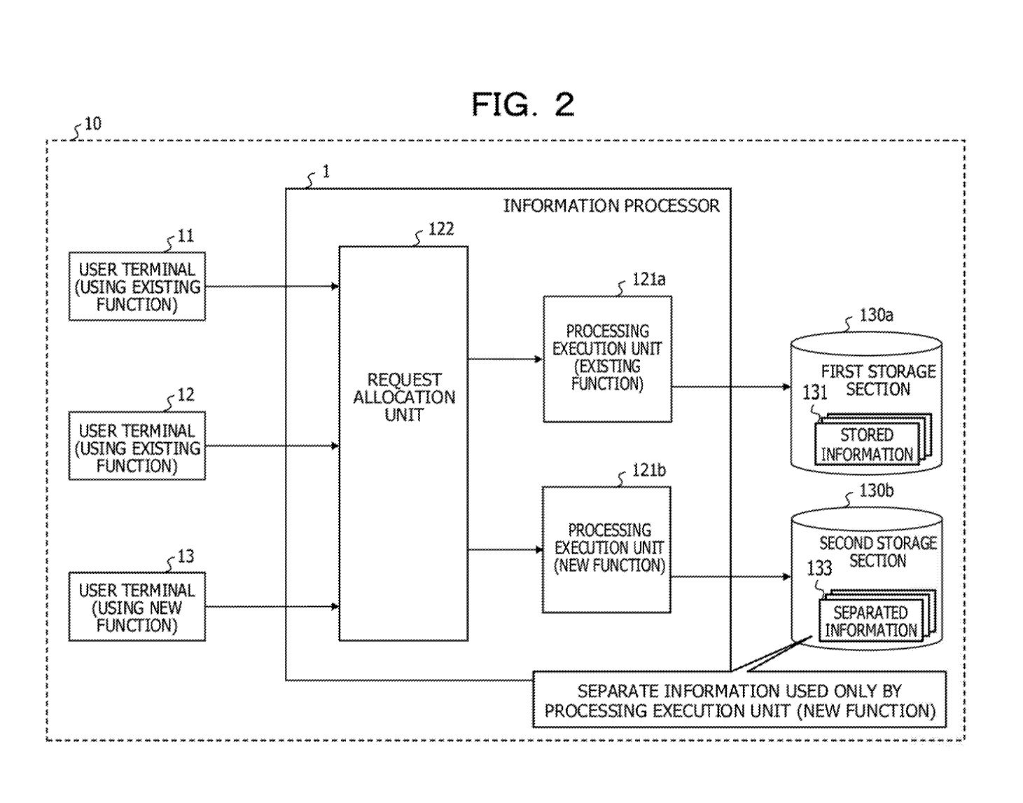

A specific example of the information processor 1 when canary release is performed is described hereinafter. FIGS. 2 to 4 are diagrams illustrating the specific example of the information processor 1 when the canary release is performed.

A central processing unit (CPU) of the information processor 1 illustrated in FIG. 2 operates as a processing execution unit 121a (hereinafter referred to as a second processing unit 121a) configured to implement existing functions by cooperating with a previously released program (hereinafter referred to as a program A). The CPU of the information processor 1 illustrated in FIG. 2 also operates as a processing execution unit 121b (hereinafter referred to as a first processing unit 121b) configured to implement a new function by cooperating with a newly released program (hereinafter referred to as a program B).

More specifically, in an example illustrated in FIG. 2, the existing function is a function that is used by a user to some extent, for example. Thus, the program A is, for example, a program that is judged by the business operator to have no unknown bug. On the other hand, in the example illustrated in FIG. 2, the new function is, for example, a function which has been used only for a short period by a user. Thus, the program B is a program for which it has not been judged that no unknown bug is included.

In addition, the CPU of the information processor 1 illustrated in FIG. 2 operates as a request allocation unit 122 configured to allocate a processing request transmitted from the user terminal 11, 12, or 13 to either the processing execution unit 121a or the processing execution unit 121b. Specifically, in the example illustrated in FIG. 2, the request allocation unit 122 allocates to the processing execution unit 121a a processing request transmitted from the user terminal 11 or 12 used by a user who uses the existing function. In the example illustrated in FIG. 2, the request allocation unit 122 also allocates to the processing execution unit 121b a processing request transmitted from the user terminal 13 used by a user who uses the new function.

Then, based on content of the processing request allocated by the request allocation unit 122, the processing execution unit 121b accesses a second storage section 130b in which separated information 133 (for example, information related to the user who uses the new function) is stored. In addition, based on content of the processing request allocated by the request allocation unit 122, the processing execution unit 121a accesses a first storage section 130a in which stored information 131 is stored.

More specifically, when performing canary release on the information processor 1, the business operator causes the processing execution unit 121a operating to implement the existing function and the processing execution unit 121b operating to implement the new function to operate concurrently. Then, in the example illustrated in FIG. 2, the business operator causes the processing execution unit 121b to execute only a processing request transmitted through the user terminal 13. In addition, the business operator separates the separated information 133 only accessed by the processing execution unit 121b from the stored information 131, and stores the separated information 133 in the second storage section 130b.

This makes it possible to confine any impact of an unknown bug within the separated information 133 even when an unknown bug is included in the program to implement the new function (released program), when the processing execution unit 121b accesses the second storage section 130b only. Thus, performing the canary release makes it possible for the business operator to control any impact on the business system caused when an unknown bug is included in a released program.

Here, when a program is released, the business operator generally makes a next release after a predetermined period of time elapses. In other words, the business operator does not make a next release on the Information processor 1 until a new function by the program released to the information processor 1 is used to some extent, and the business operator is able to judge whether or not destruction of information involved in the program release occurs.

This allows the business operator to avoid occurrence of a condition in which when the destruction of information has occurred owing to released programs, the program that has caused the destruction of information is not able to be identified because programs are concurrently released multiple times. Thus, in this case, it is possible for the business operator to identify the cause of the occurred destruction of information quickly.

In the canary release as described above, however, users who use the new function by the released program are limited. Thus, when the canary release is performed, it takes more time for the new function by the released program to be used to some extent and a judgment to be made on whether or not the destruction of information involved in the program release occurs than when a normal release is performed. In the following, specific examples when the canary release and the normal release are performed respectively are described.

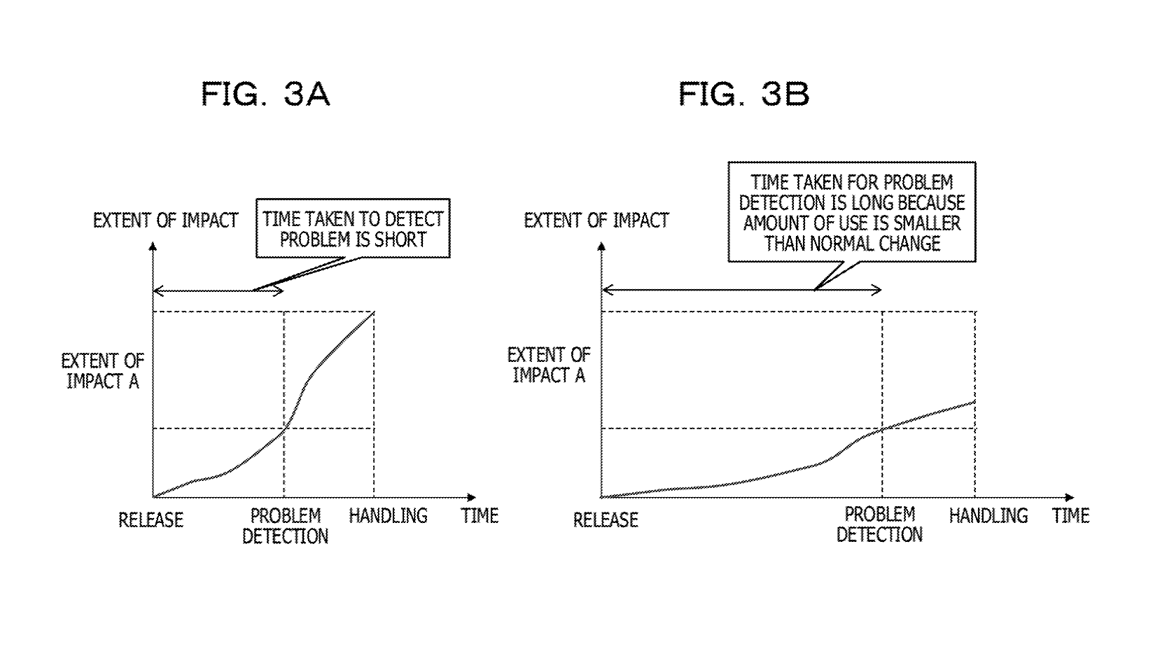

FIGS. 3A and 3B are diagrams illustrating a specific example when the canary release and the normal release are performed on a program in which an unknown bug is included. Specifically, FIG. 3A is a graph illustrating a relationship among timing of release in the case of the normal release, timing when presence of an unknown bug is detectable, and timing when the unknown bug is handled. In addition, FIG. 3B is a graph illustrating a relationship among timing of release in the case of canary release, timing when presence of an unknown bug is detectable, and timing when the unknown bug is handled.

In FIGS. 3A and 36, a horizontal axis represents time, and a vertical axis the extent of the impact on the information processor 1 or the like of the unknown program included in the released program. Then, “release”, “problem detection”, and “handling” on the horizontal axis in FIGS. 3A and 3B respectively represent the timing of release in the case of canary release, the timing when presence of an unknown bug is detectable, and the timing when the unknown bug is handled. In addition, “extent of impact A” on the vertical axis in FIGS. 3A and 3B is the extent of the impact desired to detect that an unknown bug is included in the program released by the business operator.

The canary release is designed to limit the extent of the impact even when an unknown bug is included in a released program by letting limited users use a new function by the released program after the program release. Thus, the new function by the program released through the canary release will be used less often by users than a new function by the program released through the normal release. Therefore, as illustrated in FIGS. 3A and 3B, time taken along the vertical axis of the graph in FIG. 3B to reach the “extent of the Impact A” (time taken along the horizontal axis of the graph to reach “problem detection” from “release”) is longer than time till the vertical axis of the graph in FIG. 3A reaches the “extent of the impact A”.

Thus, when performing the canary release on the information processor 1, the business operator has to set an interval of program releases on the information processor 1 longer than a case of making a normal release.

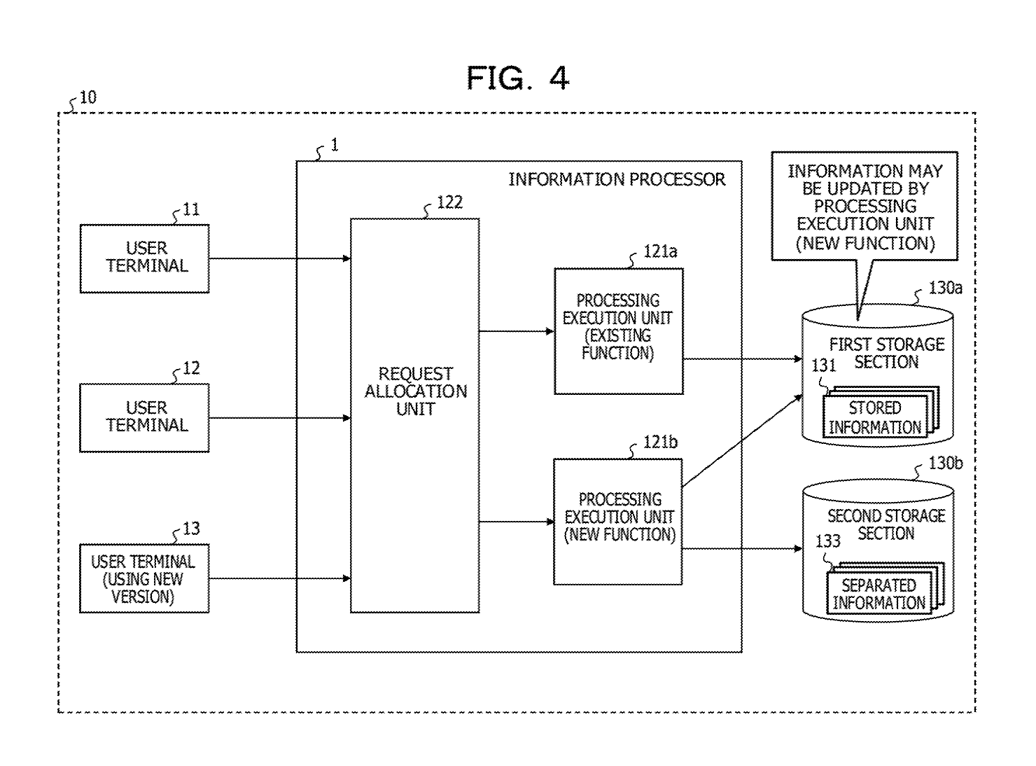

In addition, as illustrated in FIG. 2, even if the separated information 133 and the stored information 131 are separately managed, depending on content of processing of the new function by the released program, the new function is likely to access the stored information 131, as illustrated in FIG. 4. Thus, in this case, it is not possible for the business operator to limit the impact of the unknown bug only to the separated information 133 stored in the second storage section 130b.

Then, when receiving an update request of the stored information 131, the information processor 1 in the first embodiment updates difference information 134 (information to which a part of the stored information 131 stored in the first storage section 130a is transferred) of a difference storage section 130c. Then, when receiving a merge request, the information processor 1 stores in the first storage section 130a the difference information 134 stored in the difference storage section 130c. In the following, information control processing in the first embodiment is described.

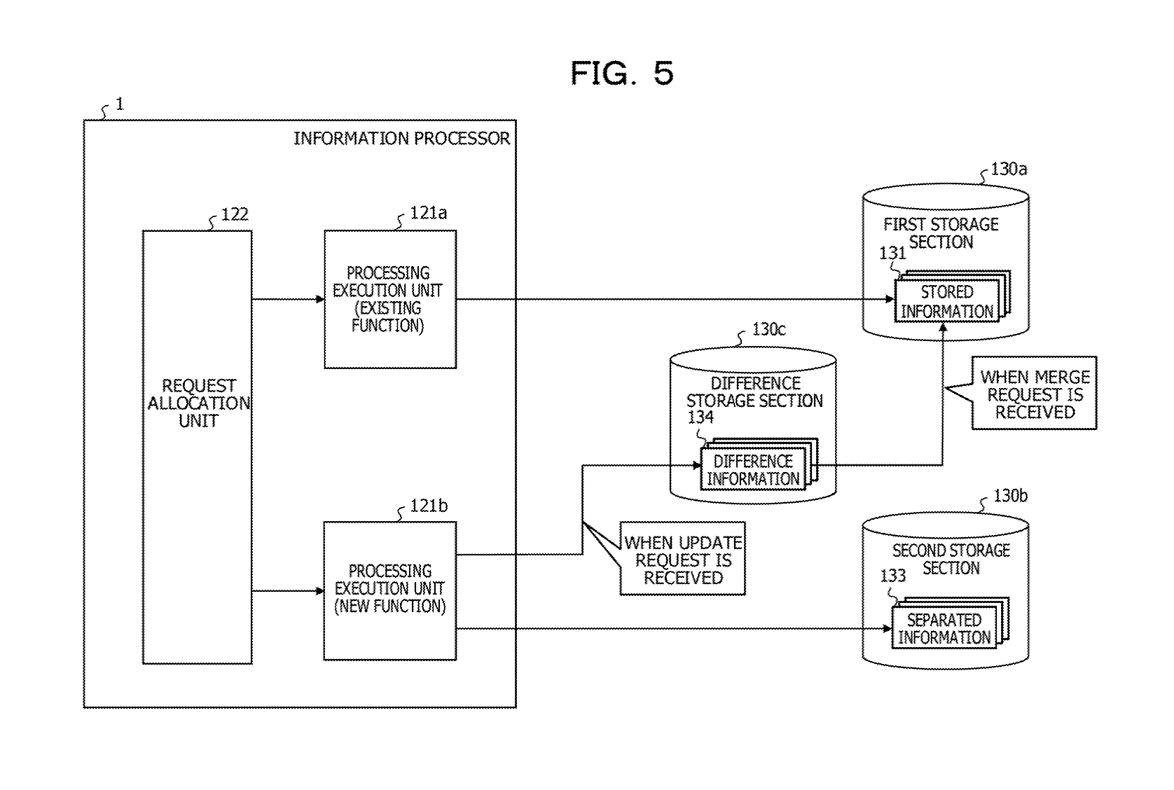

FIG. 5 is a diagram outlining information control processing in the first embodiment. As illustrated in FIG. 5, the information processor 1 updates the difference information 134 which is a part of the stored information 131 that has been stored in the first storage section 130a and transferred to the difference storage section 130c. More specifically, the information processor 1 in the first embodiment does not update the stored information 131 stored in the first storage section 130a.

This allows the information processor 1 to limit any impact of an unknown bug to the difference information 134 stored in the difference storage section 130c even when the unknown bug is included in a released program. Thus, even when an unknown bug is included in the released program, it is possible for the information processor 1 to keep the impact of the unknown bug from extending to the stored information 131 stored in the first storage section 130a.

In addition, the information processor 1 limiting the impact of the unknown bug to the difference information 134 stored in the difference storage section 130c makes it possible for the business operator to shorten an interval of performing canary release.

[A Hardware Configuration of the Information Processor]

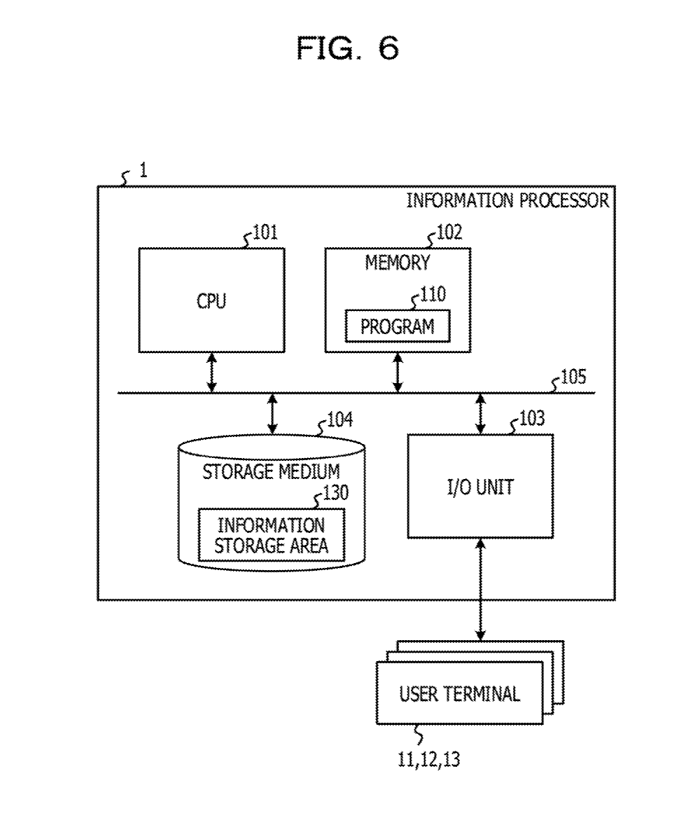

A hardware configuration of the information processor 1 is described hereinafter. FIG. 6 is a diagram illustrating a hardware configuration of an information processor 1.

The information processor 1 has a CPU 101, which is a processor, a memory 102, an external interface (I/O unit) 103, and a storage medium (storage) 104. Each unit is connected with each other by way of a bus 105.

The storage medium 104 stores in a program storage area (not illustrated) in the storage medium 104 a program 110 configured to execute processing to control (hereinafter referred to as information control processing) information accessed by a new function by a released program.

As illustrated in FIG. 6, when the program 110 is executed, the CPU 101 loads the program 110 from the storage medium 104 to the memory 102 and executes the information control processing in cooperation with the program 110.

The storage medium 104, for example, has an information storage area 130 that stores information to be used in executing the information control processing. In addition, the external interface 103 communicates with the user terminals 11, 12, and 13. Note that the information storage area 130 corresponds to the storage section 2 illustrated in FIG. 1.

[A Software Configuration of the Information Processor]

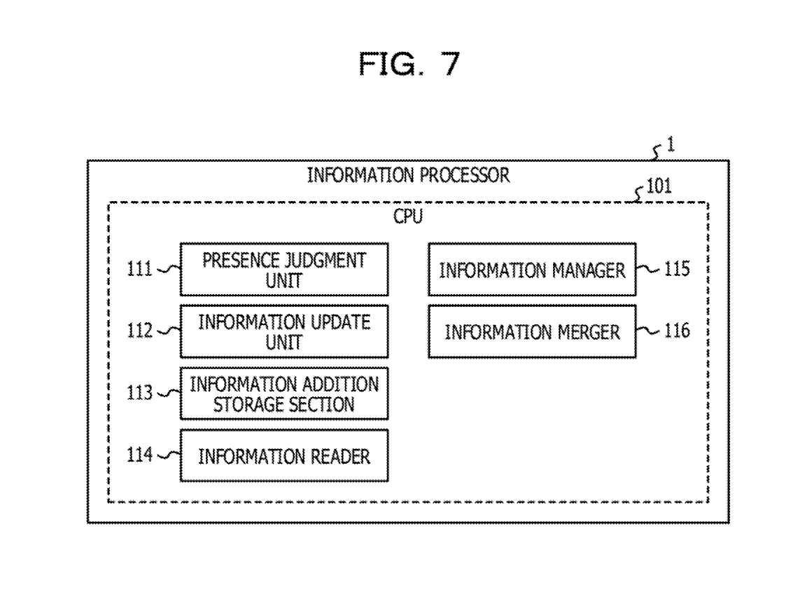

A software configuration of the information processor 1 is described hereinafter. FIG. 7 is a block diagram of each function of the information processor 1. The CPU 101 operates as a presence judgment unit 111, an information update unit 112, and an information addition storage section 113 by cooperating with a program 110. The CPU 101 also operates as an information reader 114, an information manager 115, and an information merger 116, by cooperating with the program 110. Note that the presence judgment unit 111, the information update unit 112, the Information addition storage section 113, the information reader 114, and the Information manager 115 operate when a processing execution unit 121b executes a processing request allocated by the request allocation unit 122.

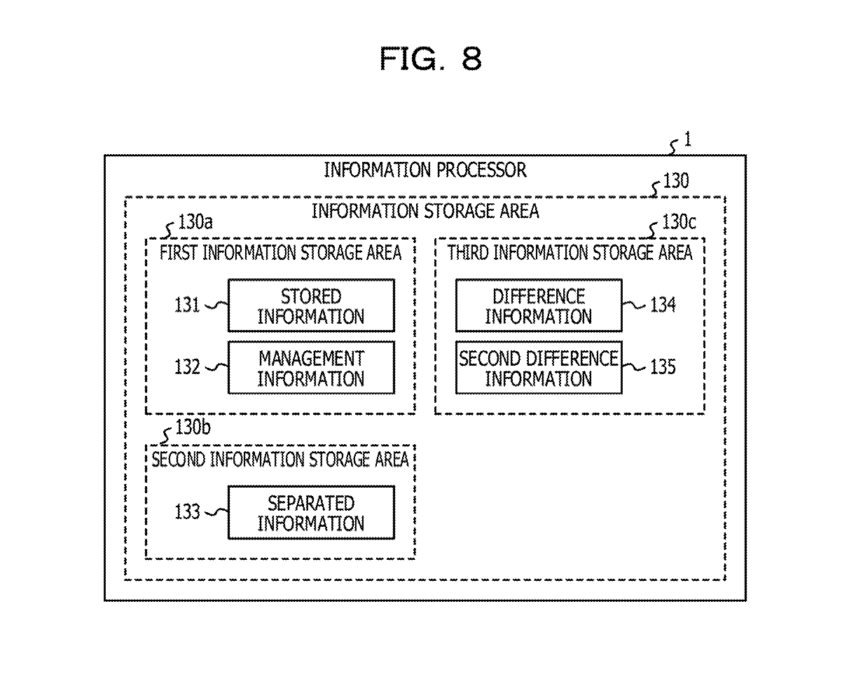

In addition, FIG. 8 is a block diagram of information stored in an Information storage area 130 of the information processor 1. As illustrated in FIG. 8, in the information storage area 130, there are a first information storage area 130a (hereinafter also referred to as a first storage section 130a or a storage section 130a), a second information storage area 130b (hereinafter also referred to as a second storage section 130b), and a third information storage area 130c (hereinafter referred to as a difference storage section 130c).

Then, the first storage section 130a stores stored information 131 and management information 132, and the second storage section 130b stores separated information 133. In addition, the difference storage section 130c stores difference information 134 and second difference information 135.

The presence judgment unit 111 judges whether or not the difference storage section 130c is present before the information update unit 112 executes an update request for the stored information 131 in response to the execution of a processing request by the processing execution unit 121b. Accordingly, when the presence judgment unit 111 judges that the difference storage section 130c is not present, the information manager 115 creates a difference storage section 130c. Then, after creating the difference storage section 130c, the Information manager 115 transfers some information of the stored information 131 to the difference storage section 130c as difference information 134 and stores the difference information 134.

In addition, the presence judgment unit 111 judges whether or not the difference storage section 130c is present, before the information addition storage section 113 executes an additional storage request in response to execution of the processing request performed by the processing execution unit 121b. Accordingly, if it is judged that no difference storage section 130c is present, the information manager 115 creates the difference storage section 130c.

Note that the stored information 131 and the difference information 134 may be information including numeric value information, for example. In addition, in this case, the update request may be a request that increases or decreases a value indicated by the stored information 131 or the difference information 134.

When receiving an update request from the processing execution unit 121b, the information update unit 112 updates the difference information 134 stored in the difference storage section 130c.

When receiving an additional storage request from the processing execution unit 121b, the information addition storage section 113 stores in the difference storage section 130c information corresponding to the additional storage request as at least a part of the second difference information 135.

When receiving a read request from the processing execution unit 121b, the information reader 114 reads information based on the read request.

For example, when receiving a merge request from the business operator, the information merger 116 stores in the first storage section 130a Information stored in the difference storage section 130c. Specifically, when difference information 134 is stored in the difference storage section 130c, for example, the information merger 116 merges the difference information 134 with the stored information 131 stored in the first storage section 130a. In addition, for example, when the difference information 134 and the second difference information 135 are stored in the difference storage section 130c, the information merger 116 merges the difference information 134 and the second difference information 135 with the stored information 131 stored in the first storage section 130a. Note that management information 132 is described later. In addition, specific examples of the stored information 131, the management information 132, the difference information 134, and the second difference information 135 are described later.

### An Outline of the First Embodiment

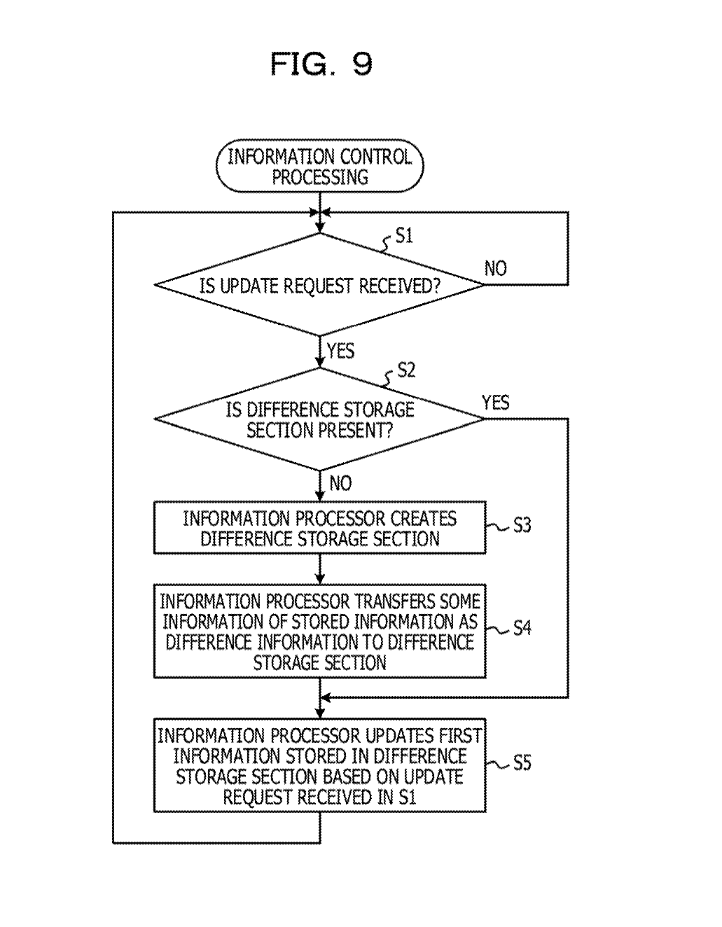

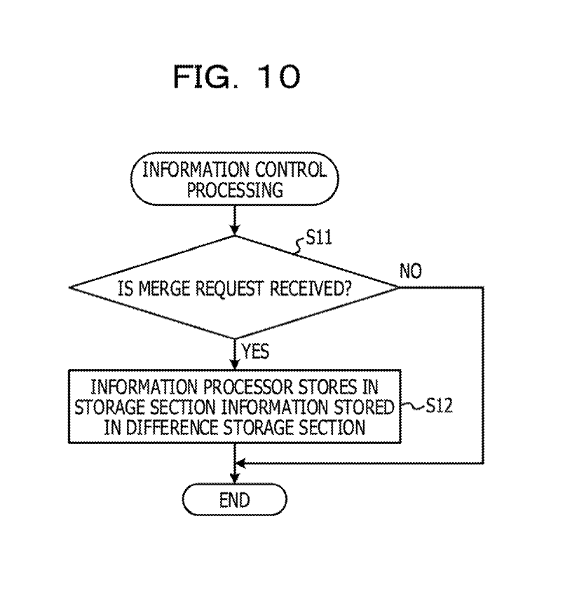

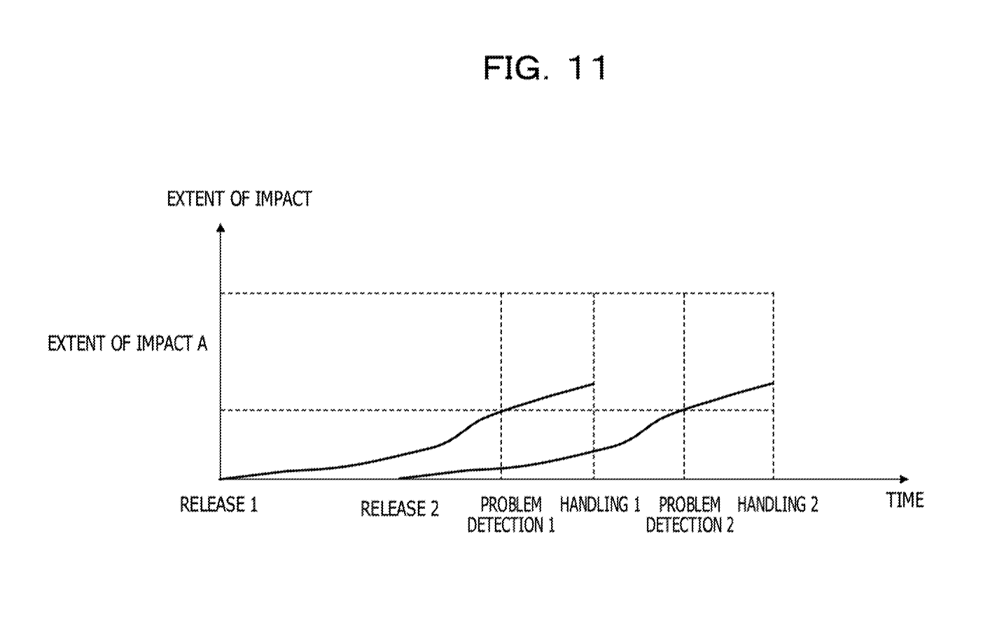

An outline of the first embodiment is described hereinafter. FIGS. 9 and 10 are flow charts outlining the information control processing in the first embodiment FIG. 11 is a diagram outlining the information control processing in the first embodiment. The information processor in FIGS. 9 and 10 is described with reference to FIG. 11.

First, the information processor 1 waits until an update request of stored information 131 is received (NO at S1). More specifically, the information processor 1 waits until the update request for the stored information 131 has to be executed as a result of execution of a processing request that is transmitted by a user using a new function through the user terminal 13. Then, when receiving the update request for the stored information 131 (YES at S1), the information processor 1 judges whether or not the difference storage section 130c is present (S2).

Accordingly, if the difference storage section 130c is not present (NO at S2), the information processor 1 creates a difference storage section 130c (S3). Then, in this case, the information processor 1 transfers some information of the stored information 131 stored in the first storage section 130a to the difference storage section 130c as difference information 134 (S4). On the other hand, when the difference storage section 130c is present (YES at S2), the information processor 1 does not execute processing of S3 and S4.

Then, the information processor 1 updates the difference information 134 stored in the difference storage section 130c based on the update request received in the processing of S1 (S5).

More specifically, the information processor 1 manages information such that only the difference information 134 stored in the difference storage section 130c is updated based on the update request. Even if an unknown bug is included in a released program, this allows the Information processor 1 to limit the extent of the impact of the unknown bug to the difference information 134 stored in the difference storage section 130c. Then, it is possible for the information processor 1 to keep the Impact of the unknown bug from extending to the stored information 131 stored in the first storage section 130a. In addition, the impact of the unknown bug being limited to the difference information 134 makes it possible for the business operator to shorten an interval of performing canary releases.

Then, as illustrated in FIG. 10, the Information processor 1 waits until the Information processor 1 receives from a business operator's terminal (not illustrated) used by the business operator a merge request to merge stored information 131 stored in the first storage section 130a and difference information 134 stored in the difference storage section 130c (NO at S11). Then, when receiving the merge request (YES at S11), the information processor 1 stores in the first storage section 130a the difference information 134 stored in the difference storage section 130c (S12).

More specifically, when the new function by the released program is used by the users to some extent, and the timing when it is possible to judge whether or not destruction of data involved in a program release occurs has come, the business operator judges that no unknown bug is included in the released program, for example. Then, in this case, the business operator transmits a merge request to the information processor 1 through the business operator's terminal (not illustrated) and merges the stored information 131 stored in the first storage section 130a with the difference information 134 stored in the difference storage section 130c. This allows the business operator to manage information in a form in which the stored information 131 and the difference information 134 are not separated in the same way as before the difference storage section 130c is created.

In this manner, the information processor 1 judges whether or not the difference storage section 130c that stores some information of the stored information 131 as difference information 134 is present, in response to receipt of an update request for the stored information 131 stored in the first storage section 130a. Then, when the information processor 1 judges that no difference storage section 130c is present, the information processor 1 creates a difference storage section 130c and transfers the difference information 134 to the difference storage section 130c. Then, the information processor 1 updates the difference information 134 stored in the difference storage section 130c based on the update request.

On the other hand, in response to receipt of a merge request of the stored information 131 stored in the first storage section 130a and the difference information 134 stored in the difference storage section 130c, the Information processor 1 stores the difference information 134 as a part of the stored information 131 in the first storage section 130a.

With this, the information processor 1 no longer has to directly update information stored in the first storage section when a new function by a released program updates the stored information 131. Thus, even if an unknown bug is included in the released program, it is possible for the information processor 1 to limit the impact of the unknown bug to the difference information 134 stored in the difference storage section 130c. Then, even if an unknown bug is included in the released program, it is possible for the information processor 1 to keep the impact of the unknown bug from extending to the stored information 131 stored in the first storage section 130a.

In addition, when programs are concurrently released multiple times, even if an unknown bug is included in any of released programs, it is possible for the information processor 1 to limit the impact of the unknown bug to the difference information 134. Thus, it is possible for the information processor 1 to make a next release before the timing when the information processor 1 is able to judge whether or not destruction of information involved in the earlier program release occurs.

Specifically, as illustrated in FIG. 11, it is possible for the business operator to release a next program at timing (timing of “release 2”) before timing (timing indicated by “problem detection 1”) when the business operator is able to judge whether or not destruction of information involved in the earlier program release occurs. Therefore, even if the business operator performs canary release, it is possible for the business operator to increase a frequency of releasing programs.

In addition, if programs are concurrently released multiple times, the information processor 1 may create multiple pieces of difference information 134 corresponding to each of the released programs. With this, even when an unknown bug is included in any of the released programs, it is possible for the information processor 1 to limit the impact of the unknown bug to a piece of difference information 134 corresponding to a program in which the unknown bug is included, of the multiple pieces of difference information 134.

### Details of the First Embodiment

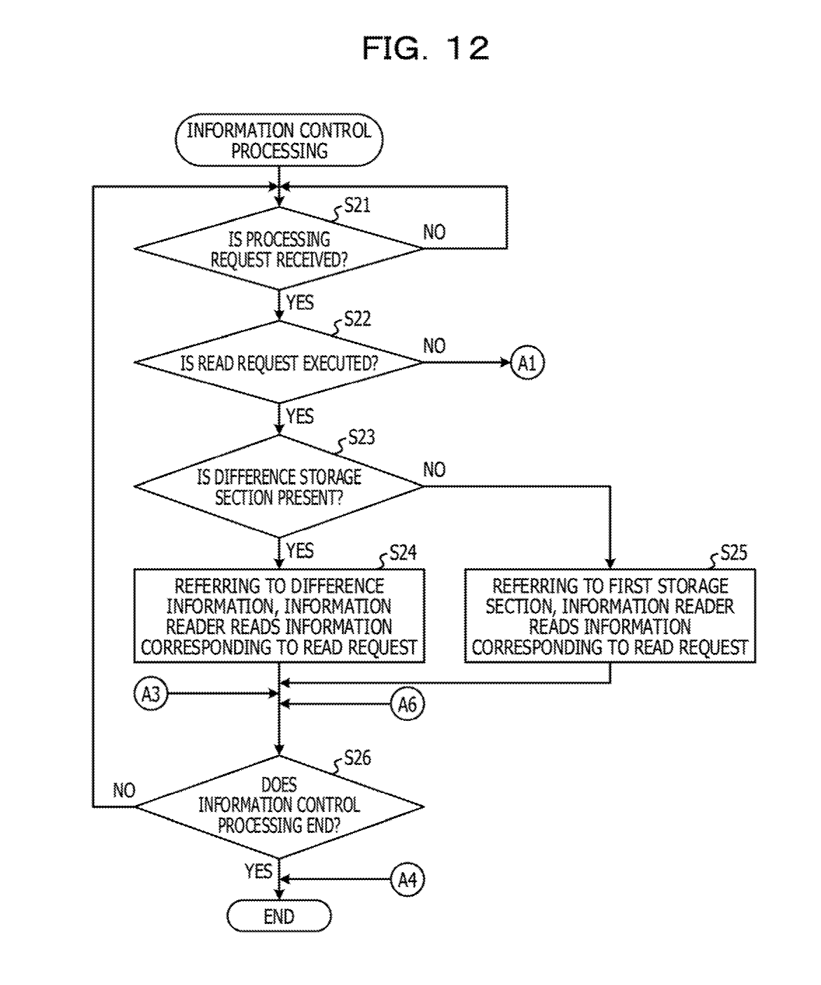

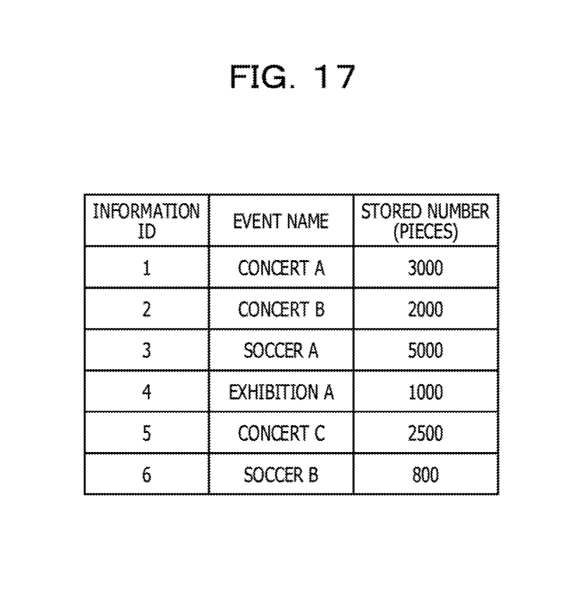

Details of the first embodiment are described hereinafter. FIG. 12 to FIG. 16 are flowcharts illustrating details of the information control processing in the first embodiment In addition, FIG. 17 to FIG. 28 are diagrams illustrating details of the information control processing in the first embodiment. The information control processing of FIGS. 12 to 16 is described with reference to FIGS. 17 to 28. Note that the following description is given on the assumption that a business system managing the number of unsold event tickets in the information processor 1 is in operation.

[Information Update Processing and Information Read Processing]

First, of the information control processing, processing to update information (hereinafter referred to as an information update processing) and processing to read information (hereinafter referred to as an Information read processing) are described.

The information allocation unit 122 waits until receipt of a processing request from the user terminals 11, 12, and 13 (NO at S21). Then, when receiving the processing request (YES at S21), the information allocation unit 122 allocates, for example, processing requests received from the user terminal 11, 12, or 13 to the processing execution unit 121a and the processing execution unit 121b. Specifically, for example, the request allocation unit 122 allocates a processing request received from the user terminal 11 or 12 to the processing execution unit 121a and a processing request received from the user terminal 13 to the processing execution unit 121b.

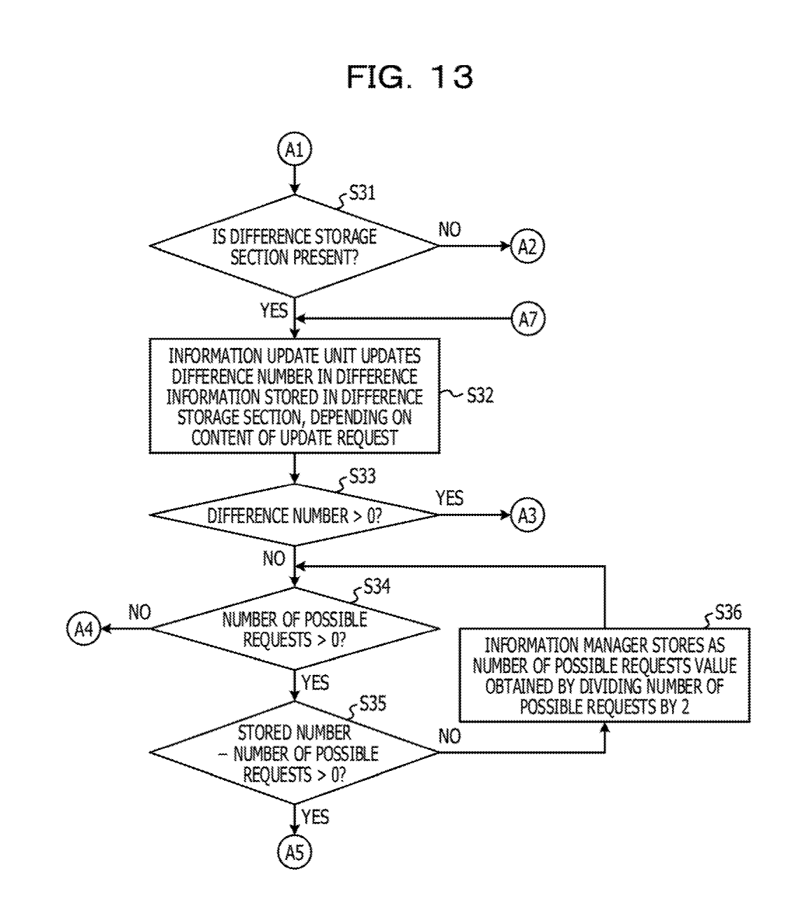

Then, when the processing request is allocated to the processing execution unit 121b, the processing execution unit 121b executes the allocated processing request. Then, if an update request for stored information 131 has to be executed as a result of execution of the processing request (NO at S22), the processing execution unit 121b instructs the presence judgment unit 111 to execute it. Specifically, in this case, the presence judgment unit 111 judges whether or not the difference storage section 130c is present, as illustrated in FIG. 13 (S31). As a result, if the difference storage section 130c is not present (NO at S31), the information manager 115 creates a difference storage section 130c and management information 132. The management information 132 is information including information of the difference storage section 130c to which a part of the stored information 131 is transferred as difference information 134. In the following, specific processing in creating a difference storage section 130c and management information 132 is described.

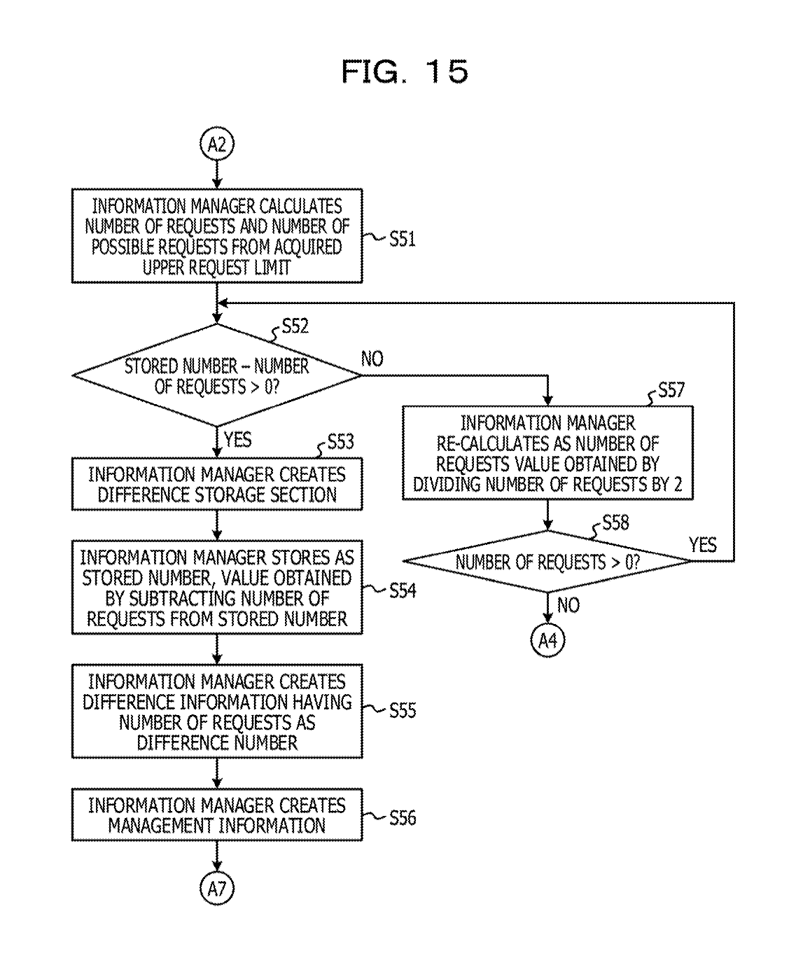

As illustrated in FIG. 15, the information manager 115 acquires an upper request limit 132a which is a value fixed by the business operator in advance (S51). The upper request limit 132a is information about a number that may be stored in the difference storage section 130c as difference information 134, of stored information 131 stored in the first storage section 130a. The upper request limit 132a may be the one stored in advance in the information storage area 130 by the business operator.

More specifically, the difference information 134 stored in the difference storage section 130c is information to be affected by an unknown bug if the unknown bug is included in a released program. Thus, the business operator has to manage such that the amount of information of the difference information 134 stored in the difference storage section 130c is as small as possible. Therefore, for example, the business operator fixes the upper request limit 132a in advance, and stores the upper request limit 132a in the information storage area 130. This allows the information manager 115 to manage information based on the upper request limit 132a.

Furthermore, the information manager 115 calculates the number of requests 132b, which is a unit of the number information of which to be transferred to the difference storage section 130c, from the acquired upper request limit 132a (S51). The information manager 115, for example, calculates as the number of requests 132b a value obtained by dividing the acquired upper request limit 132a by “2”. This allows the information manager 115 to manage such that the amount of information of the difference information 134 stored in the difference storage section 130c is small.

In addition, the information manager 115 calculates the number of possible requests 132c (S51) from the acquired upper request limit 132a. The number of possible requests is, for example, the number of pieces of information that may be further transferred to the difference storage section 130c as difference information 134, of stored information 131 stored in the first storage section 130a. Thus, for example, the information manager 115 may calculate, as the number of possible requests 132c, a value obtained by subtracting the number of requests 132b from the upper request limit 132a. In addition, the following description is given on the assumption that the upper request limit 132a is “400 (pieces)”, the number of requests 132b is “200 (pieces)”, and the number of possible requests 132c is “200 (pieces)”.

Then, the information manager 115 judges whether or not the value obtained by subtracting the number of requests 132b from the stored number 131a included in the stored information 131 is larger than “0” (S52). A specific example of stored information 131 is described hereinafter.

FIG. 17 is a diagram illustrating a specific example of stored information 131. The stored information 131 illustrated in FIG. 17 has, as items, an “Information ID” to identify each piece of information included in the stored information 131, an “Event name” to set a name of an event, and the “Stored number” to set the number of currently remaining tickets. Specifically, in the stored information 131 illustrated in FIG. 17, an “Event name” of Information with an “Information ID” of “1” is “Concert A” and the “Stored number” is “3000 (pieces)”. A description of other information in FIG. 17 is omitted. In addition, the following description is given on the assumption that the information manager 115 transfers to the difference storage section 130c a part of Information with the “Information ID” of “1” of the stored information 131 illustrated in FIG. 17 as difference information 134.

When executing the processing of S52 for the stored information 131 illustrated in FIG. 17, the Information manager 115 acquires as the stored number 131a “3000 (pieces)”, which is information stored in the “Stored number” of the “Information ID” of “1”. In addition, the information manager 115 acquires “200 (pieces)” as the number of requests 132b. Then, “2800 (pieces)”, which is a value obtained by subtracting “200 (pieces)”, the number of requests 132b, from “3000 (pieces)”, the stored number 131a, is larger than “0 (pieces)”. Thus, in this case, the information manager 115 judges whether or not the value obtained by subtracting the number of requests 132b from the stored number 131a is larger than “0” (YES at S52).

Turning back to FIG. 15, when the value obtained by subtracting the number of requests 132b from the stored number 131a is larger than “O” (YES at S52), the information manager 115 creates the difference storage section 130c (S53). Then, the information manager 115 stores the value obtained by subtracting the number of requests 132b from the stored number 131a as the stored number 131a in the first storage section 130a (S54). The stored information 131 after the processing of S54 is executed is described hereinafter.

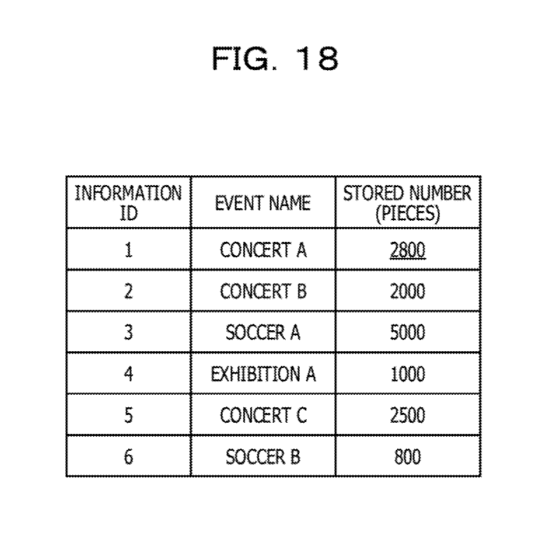

FIG. 18 is a diagram illustrating the stored information 131 after processing of S54 is executed. The information manager 115 calculates “2800 (pieces)”, which is the value obtained by subtracting “200 (pieces)”, the number of requests 132b, from “3000 (pieces)”, which is a value set in the “stored number” of the information with the “Information ID” of “1” of the stored information 131 illustrates in FIG. 17. Then, the Information manager 115 sets “2800 (pieces)” for the “stored number” of the information with the “Information ID” of “1” of the stored information illustrated in FIG. 18, as illustrated by the underlined part in FIG. 18. More specifically, the information manager 115 stores as a new stored number 131a a value obtained by subtracting the number which is information to be transferred to the difference storage section 130c, from the current stored number 131a.

Turning back to FIG. 15, the information manager 115 creates difference information 134 having the number of requests 132b as the difference number 134a (S55). Then, the information manager 115 stores the created difference information 134 in the difference storage section 130c. A specific example of difference information 134 created in the processing of S55 is described hereinafter.

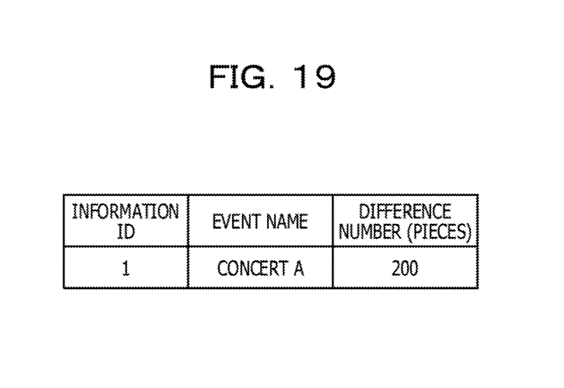

FIG. 19 is a diagram illustrating the difference information 134 created in the processing of S55. The difference information 134 illustrated in FIG. 19 has the same items as the stored information 131 illustrated in FIG. 17 and the like. Specifically, as illustrated in FIG. 19, the information manager 115 sets “1” for the “Information ID”, “Concert A” for the “Event name”, and “200 (pieces)”, which is the number of requests 132, for the “Difference number”.

More specifically, in the processing of S31 of FIG. 13, if the difference storage section 130c is not present, the information manager 115 creates difference information 134 for which a part of the value set for the stored number 131a of the stored information 131 is set for the difference number 134a. This allows the information manager 115 to limit information to be updated by the new function of the released program (program in which an unknown bug may be included) only to the difference number 134a of the difference information 134.

Turning back to FIG. 15, the information manager 115 creates management information 132 (S56). Then, the information manager 115 stores the created management information 132 in the first storage section 130a. A specific example of the management information 132 created in the processing of S56 is described hereinafter.

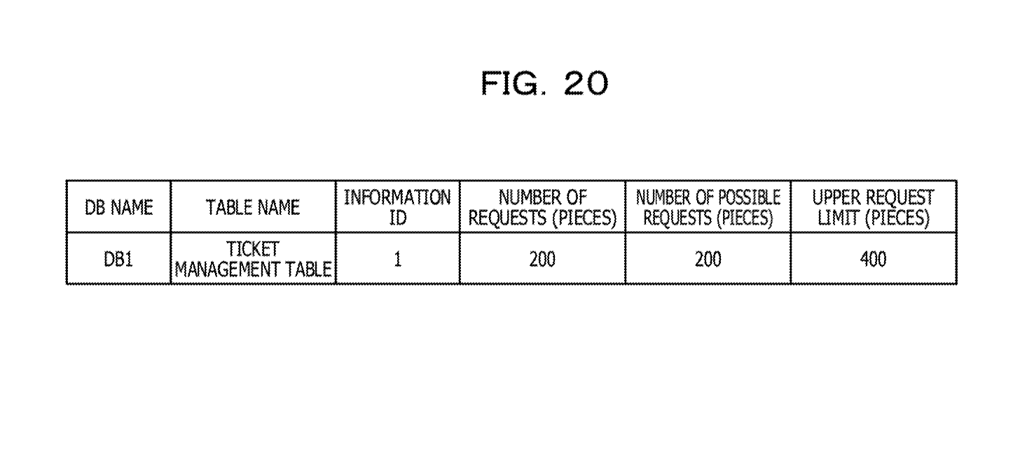

FIG. 20 is a diagram illustrating a specific example of management information 132 created in the processing of S56. In addition, the following description is given on the assumption that a name of a database (DB) that stores the stored information 131 illustrated in FIG. 17 or the like is a “DB1” and a table name of the stored information 131 is a “Ticket management table”.

The management information 132 illustrated in FIG. 20 has, as items, a “DB name” to identify the database (DB) that stores the stored information 131 managed by the management information 132 and a “Table name” to identify the table name of the stored information 131 managed by the management information 132. In addition, the management information 132 illustrated in FIG. 20 has an “Information ID” corresponding to the “Information ID” of the stored information 131 as an item. In addition, the management information 132 illustrated in FIG. 20 has the “Number of requests” to set the number of requests 132b, the “Number of possible requests” to set the number of possible requests 132c, and the “Upper request limit” to set the upper request limit 131a.

Specifically, as illustrated in the management information 132 illustrated in FIG. 20, the information manager 115, for example, sets “DB1” for the “DB name”, “Ticket management table” for the “table name”, and “1” for the “Information ID”. As illustrated in the management information 132 illustrated in FIG. 20, the information manager 115, for example, sets “200 (pieces)” for the “Number of requests”, “200 (pieces)” for the “number of possible requests”, and “400 (pieces)” for the “upper request limit”. This allows the information manager 115 to manage information related to a destination of the stored information 131 transferred as difference information 134.

Turning back to FIG. 15, in the processing of S52, if the value obtained by subtracting the number of requests 132b from the stored number 131a is equal to or smaller than “0” (NO at S52), the information manager 115 re-calculates as a new number of requests 132b a value obtained by dividing the current number of requests 132b by “2” (S57).

More specifically, in the processing of S52, the case in which the value obtained by subtracting the number of requests 132b from the stored number 131a is equal to or smaller than “0” is a case in which the stored number 131a has decreased due to frequent executions of the processing by the processing execution unit 121a illustrated in FIG. 2. Thus, in this case, the information manager 115 re-calculates the number of requests 132b such that the number which is information to be transferred to the difference storage section 130c from the first storage section 130a is small. This allows the Information manager 115 to manage information in a form that fits the current stored number 131a.

Then, if the number of requests 132b calculated in the processing of S57 is larger than “0” (YES at 558), the information manager 115 performs the processing of S52 and onward. On the other hand, if the number of requests 132b calculated in the processing of S57 is equal to or smaller than “0” (NO at 558), the information manager 115 terminates the information control processing. More specifically, in this case, the Information manager 115 judges that information that may be transferred to the difference storage section 130c as difference information 134 of the stored information 131 is not present, and terminates the information control processing. Note that in this case, the Information manager 115 may perform error notification to the administrator.

Turning back to FIG. 13, if the difference storage section 130c is present (YES at S31), the information update unit 112 updates the difference number 134a of the difference information 134 stored in the difference storage section 130c, depending on content of the update request (S32). A specific example of the difference information 134 after the processing of S32 is performed is described hereinafter.

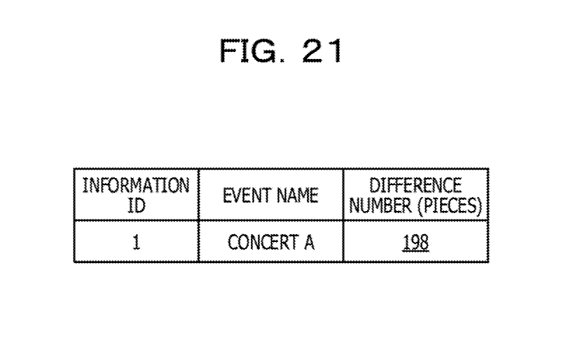

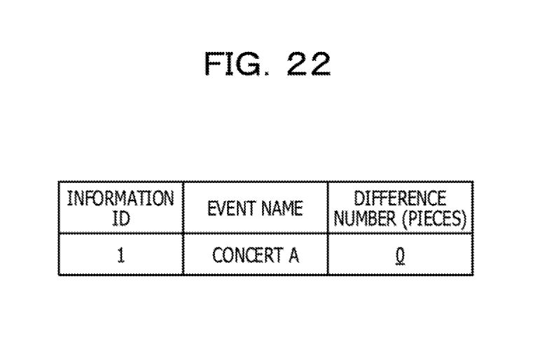

FIGS. 21 and 22 are diagrams illustrating a specific example of the difference information 134 after the processing of S32 is executed. For example, if the processing execution unit 121b receives a processing request that requests sale of two tickets of Concert A, the Information update unit 112 updates the value set for the “difference number” illustrated in FIG. 21 from “200 (pieces)” to “198 (pieces)” as indicated at the underlined part in FIG. 21.

More specifically, in this case, the information update unit 112 updates only the difference number 134a of the difference information 134 without updating the stored number 131a of the stored information 131 illustrated in FIG. 18. With this, even if an unknown bug is included in a released program, it is possible for the information update unit 112 to limit any impact of the unknown bug to the difference number 134a of the difference information 134.

Turning back to FIG. 13, the information manager 115 judges whether or not the difference number 134a of the difference information 134 is larger than “0” (S33). Then, if the difference number 134a of the difference information 134 is larger than “0” (YES at S33), the Information manager 115 executes the processing of S26 of FIG. 12 and onward. On the other hand, as illustrated by the underlined part of FIG. 22, when the difference number 134a is equal to or smaller than “0” (NO at S33), the information manager 115 judges whether or not the number of possible requests 132c of the management information 132 is larger than “0” (S34).

As a result, when the number of possible requests 132c of the management information 132 is larger than “0” (YES at S34), the information manager 115 judges whether or not the value obtained by subtracting the number of possible requests 132c from the stored number 131a is larger than “0” (S35). On the other hand, when the number of possible requests 132c is equal to or smaller than “0” (NO at S34), the information manager 115 terminates the Information control processing. More specifically, in this case, the information manager 115 judges that information that may be transferred to the difference storage section 130c as difference information 134 of the stored information 131 is not present, and terminates the information control processing. Then, in this case, the information manager 115 may perform error notification to the administrator.

In addition, in the processing of S33, the information manager 115 may judge whether or not the difference number 134a of the difference information 134 is larger than a predetermined threshold (number larger than “0”). Then, in the processing of S33, when the difference number 134a falls below the predetermined threshold, the information manager 115 may execute the processing of S34 and onward. A specific example of the processing of S34 and S35 is described hereinafter.

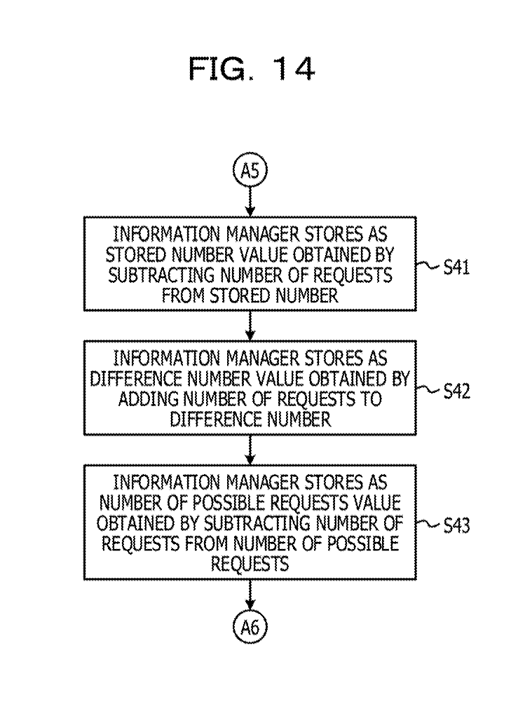

In the management information 132 illustrated in FIG. 20, since the value set for the “number of possible requests” is “200 (pieces)”, the value is larger than “0 (pieces)” (YES at S34). In addition, in the stored information 131 illustrated in FIG. 18, “2800 (pieces)” Is set for the “stored number” of the information with the “Information ID” of “1”. Thus, “2600 (pieces)”, which is a value obtained by subtracting “200 (pieces)” set for the “number of possible requests” of the management information illustrated in FIG. 20 from “2800 (pieces)” set for the “stored number” of the information with the “Information ID” of “1”, is a value larger than “0 (pieces)” (YES at S35). Therefore, in this case, the information manager 115 executes the processing of S41 of FIG. 14 and onward.

Turning back to FIG. 13, when the value obtained by subtracting the number of possible requests 132c from the stored number 131a is equal to or smaller than “0” (NO at S35), the information manager 115 stores, as a new number of possible requests 132c, a value obtained by dividing the current number of possible requests 132c by “2” in the first storage section 130a (S36).

More specifically, depending on status of the processing request received by the processing execution unit 121a Illustrated in FIG. 2, the stored number 131a decreases and the value obtained by subtracting the number of possible requests 132c from the stored number 131a may be equal to or smaller than “0”. Thus, in this case, the information manager 115 reduces the number of possible requests 132c in the processing of S36. This allows the information manager 115 to manage information in a form that fits the current stored number 131a.

Turning back to FIG. 13, when the value obtained by subtracting the number of possible requests 132c from the stored number 131a is larger than “0” (YES at S35), the information manager 115 stores as a new stored number 131a the value obtained by subtracting the number of requests 132b from the current stored number 131a in the first storage section 130a as illustrated in FIG. 4 (S41). In addition, the Information manager 115 stores a value obtained by adding the number of requests 132b to the current difference number 134a as a new difference number 134a in the difference storage section 130c (S42). Furthermore, the Information manager 115 stores as a new number of possible requests 133c the value obtained by subtracting the number of requests 132b from the current number of possible requests 132c in the difference storage section 130 (S43). Then, the information manager 115 executes the processing of S26 of FIG. 12 and onward. A specific example of the processing from S41 to S43 is described hereinafter.

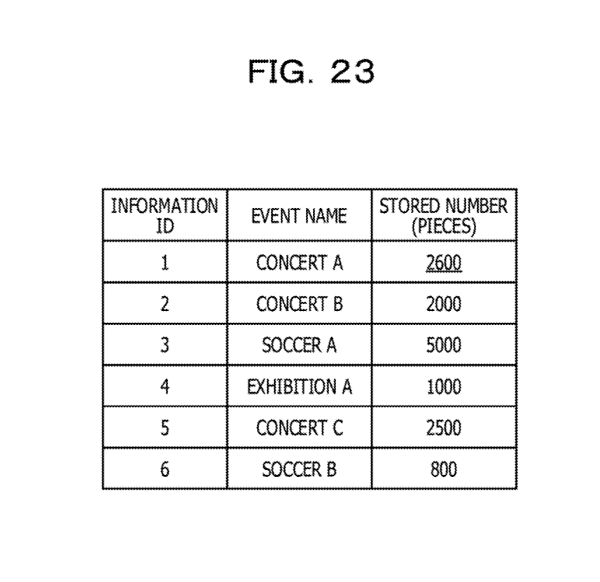

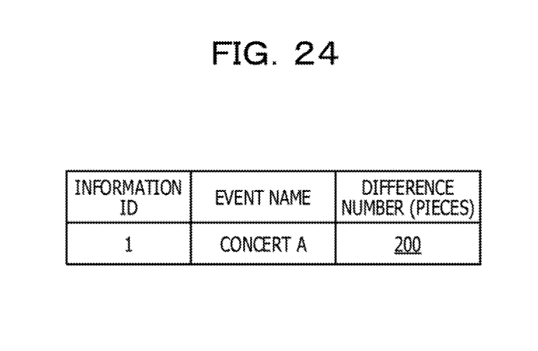

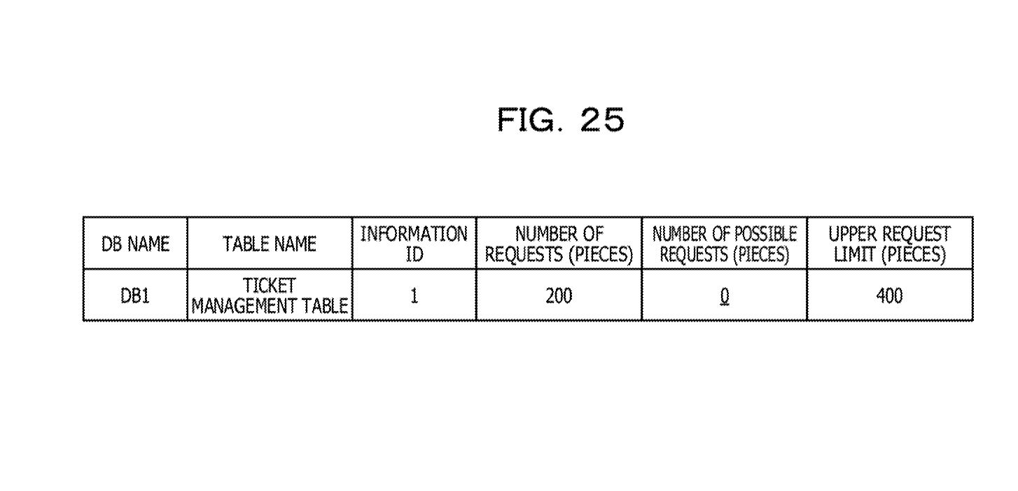

FIG. 23 is a diagram illustrating a specific example of the stored information 131 after the processing of S41 is executed. In addition, FIG. 24 is a diagram illustrating a specific example of the difference information 134 after the processing of S42 is executed. FIG. 25 is a diagram illustrating a specific example of the management information 132 after the processing of S43 is executed.

The value set for the “stored number” of the information with the “Information ID” of “1” In the stored information 131 illustrated in FIG. 18 is “2800 (pieces)”. In addition, the value set for the “number of requests” of the management information 132 illustrated in FIG. 20 is “200 (pieces)”. Thus, as illustrated in the underlined part of FIG. 23, the information manager 115 stores “2600 (pieces)” obtained by subtracting “200 (pieces)” from “2800 (pieces)”, as the “stored number” of the information with the “Information ID” of “1” (S41).

Then, the value set for the “difference number” of the difference information 134 illustrated in FIG. 22 is “0 (pieces)”. In addition, the value set for the “number of requests” of the management information illustrated in FIG. 20 is “200 (pieces)”. Thus, as illustrated in the underlined part of FIG. 24, the information manager 115 stores “200 (pieces)” which is a value obtained by adding “200 (pieces)” to “0 (pieces)” as the “difference number” of the difference information 134 (S42).

In addition, the number set for a “number of possible requests” of the management information 132 illustrated in FIG. 20 is “200 (pieces)”. In addition, the value set for the “number of requests” of the management information illustrated in FIG. 20 is “200 (pieces)”. Thus, as illustrated in the underlined part of FIG. 25, the information manager 115 stores “0 (pieces)”, which is a value obtained by subtracting “200 (pieces)” from “200 (pieces)”, as the “number of possible requests” of the management information 132 (S43).

Turning back to FIG. 12, if a read request for stored information 131 has to be executed as a result of executing processing based on the processing request (YES at S22), the processing execution unit 121b instructs the presence judgment unit 111 to execute it. Specifically, in this case, the presence judgment unit 111 judges whether or not the difference storage section 130c is present (S23).

As a result, when the difference storage section 130c is present (YES at S23), the information reader 114 refers to the difference storage section 130c and reads information corresponding to the read request of the difference information 134 (S24). On the other hand, when the difference storage section 130c is not present (NO at S23), the information reader 114 refers to the first storage section 130a and reads information corresponding to the read request of the stored information 131 (525).

More specifically, in the processing of S23, when the difference storage section 130c is not present, information targeted for the read request is present only in the first storage section 130a. Thus, in this case, the information reader 114 reads the information corresponding to the read request by referring to the first storage section 130a.

Then, for example, if the business operator has performed an input meaning that the business operator terminates the information control processing (YES at S26), the information processor 1 terminates the information control processing. On the other hand, if the business operator has not performed the input meaning that the business operator terminates the information control processing (NO at S26), the information processor 1 re-executes the processing of S21 and onward.

[Processing by the Processing Execution Unit 121a]

When receiving a processing request from the user terminal 11 or 12 in the processing of S21 of FIG. 12 (YES at S21), the request allocation unit 122 allocates the processing request received from the user terminal 11 or 12 to the processing execution unit 121a, for example.

In this case, the processing execution unit 121a performs information update or information read on stored information 131 stored in the first storage section 130a, depending on the content of the processing request allocated by the request allocation unit 122, instead of executing the processing of S22 and onward, as illustrated in FIG. 5, for example.

More specifically, a program for the processing execution unit 121a to operate is different from a program for the processing execution unit 121b to operate and is a program that has been already used by users to some extent. Then, the program for the processing execution unit 121a to operate is a program on which judgment that no unknown bug is included has been made by the business operator. Therefore, for example, when a processing request is allocated by the request allocation unit 122, the processing execution unit 121a may update the stored information 131 stored in the first storage section 130a, or perform other processing.

[Information Merge Processing]

Then, processing to merge information (hereinafter also referred to as information merge processing) of the information control processing is described hereinafter.

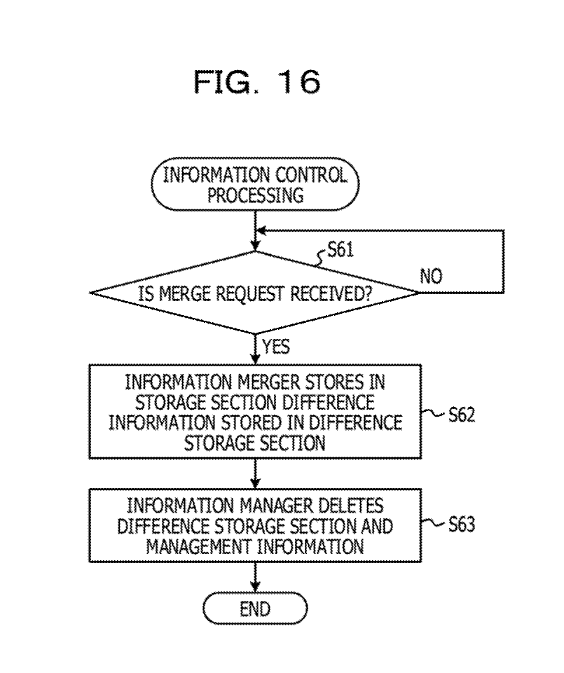

As Illustrated in FIG. 16, the Information merger 116 waits until a merge request is received from a business operator's terminal or the like, for example (NO at S61). Then, when the merge request is received (YES at S61), the information merger 116 stores in the first storage section 130a difference information 134 stored in the difference storage section 130c (S62). Then, the information manager 115, for example, deletes the difference storage section 130c and the management information 132 (S63).

More specifically, for example, when a new function by a released program is used by users to some extent and it has been judged that destruction of information due to the released program does not occur, the business operator no longer has to manage stored information 131 and difference information 134 separately. Thus, in this case, the business operator transmits the merge request to the information processor 1 and merges the stored information 131 stored in the first storage section 130a with the difference information 134 stored in the difference storage section 130c. Then, for example, the business operator deletes the difference storage section 130c and the management information 132. This allows the business operator to reduce processing load on the information processor 1 involved in separately managing the stored information 131 and the difference information 134. A specific example of the processing of S62 is described hereinafter.

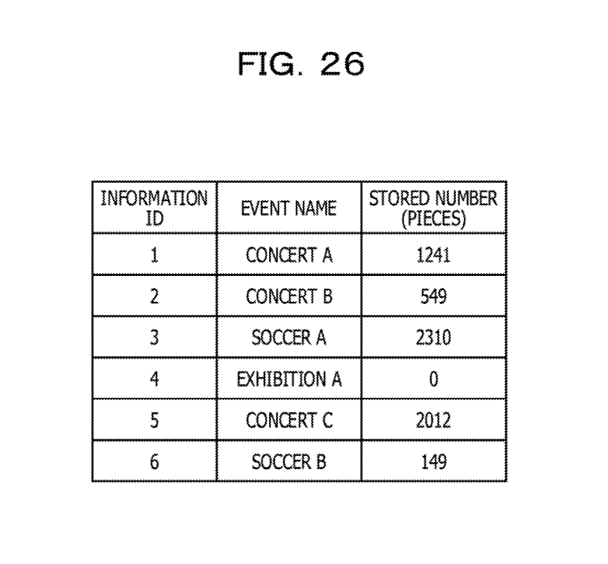

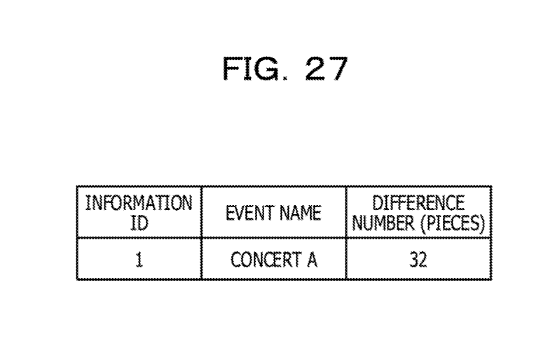

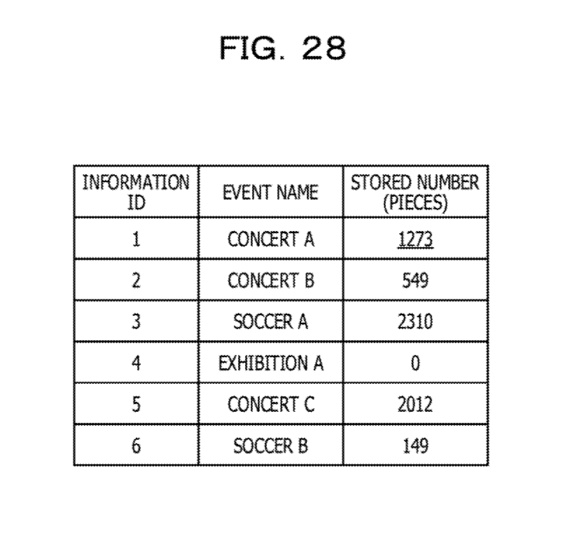

FIG. 26 is a specific example of stored information 131 before the processing of S62 is executed. In addition, FIG. 27 is a specific example of the difference information 134 before the processing of S62 is executed. Furthermore, FIG. 28 is a specific example of the stored information 131 after the processing of S62 is executed.

In the stored information 131 illustrated in FIG. 26, “1241 (pieces)” is set for the “stored number” of the information with the “Information ID” of “1”, and in the difference information 134 illustrated in FIG. 27, “32 (pieces)” is set for the “difference number” of the information with the “Information ID” of “1”.

Thus, in this case, the Information merger 116 adds “1241 (pieces)” and “32 (pieces)” to calculate “1273 (pieces)”. Then, as illustrated in the underlined part in FIG. 28, the Information merger 116 sets “1273 (pieces)” for the “stored number” of the information with the “Information ID” of “1” of the stored information 131 illustrated in FIG. 28. This allows the information merger 116 to merge the stored information 131 with the difference information 134.

In addition, for example, the information merger 116 may create, in advance, information (not illustrated) to identify an item in which the information desirably to be merged with the difference information 134 is set, out of the items included in the stored information 131. Then, by referring to the information created in advance, the information merger 116 may identify the item in which the Information desirably to be merged with the difference information 134 and merge the stored information 131 with the difference information 134.

[Information Control Processing in a Second Embodiment]

Information control processing in a second embodiment is described hereinafter. In the first embodiment are described the cases in which the difference information 134 is updated by the information update unit 112 and information is read by the information reader 113, based on content of the processing request received by the processing execution unit 121b as described in FIG. 2 or the like.

In contrast to this, the information processor 1 in the second embodiment performs additional storage of new information by the information addition storage section 113, in addition to updating the difference information 134 by the information update unit 112 and reading information by the information reader 114. This allows the information processor 1 to limit the impact of additional storage of new information performed by the information addition storage section 113, even when an unknown bug is inherent in a released program. A specific example of the information control processing in the second embodiment is described hereinafter.

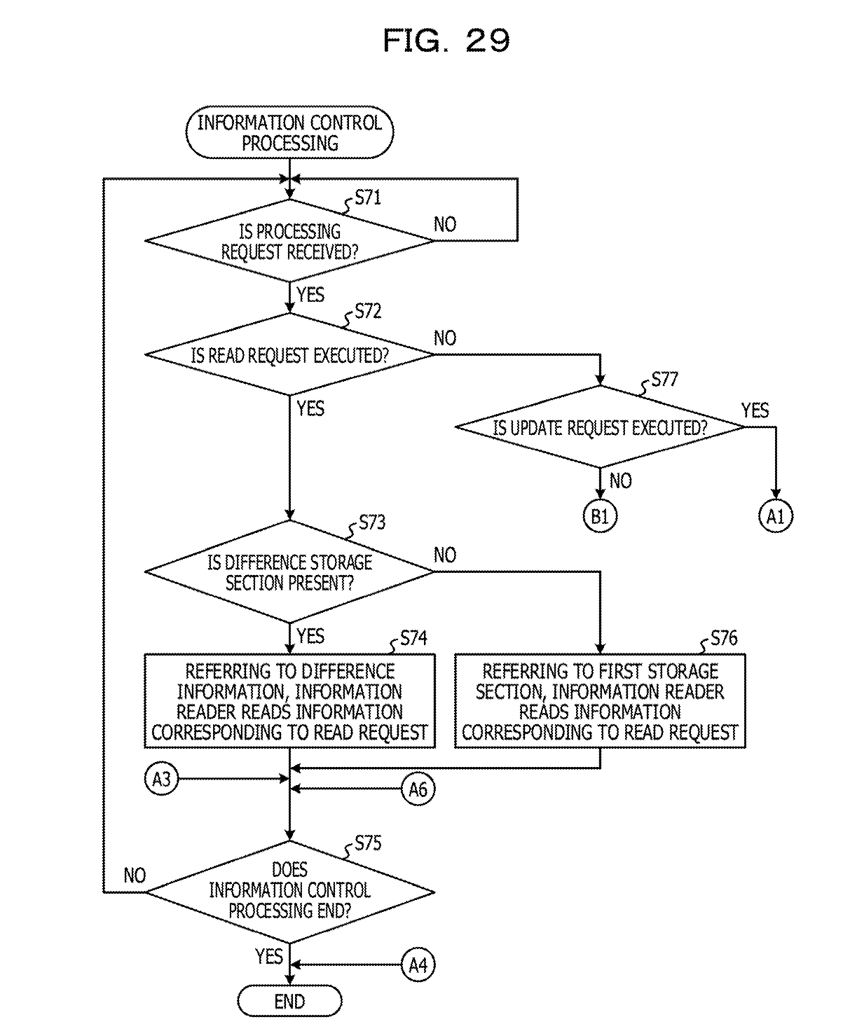

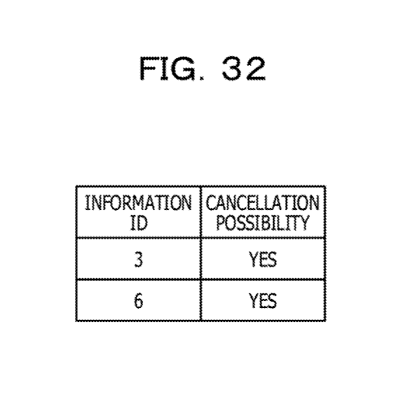

FIG. 29 to FIG. 31 are flow charts for illustrating the information control processing in the second embodiment. FIG. 32 to FIG. 34 are diagrams illustrating the information control processing in the second embodiment. The information control processing of FIG. 29 to FIG. 31 is described with reference to FIG. 32 to FIG. 34. Note that only processing which differs from the first embodiment is described in the following.

[Information Addition Storage Processing]

First, of the information control processing in the second embodiment, processing to perform additional storage of information (hereinafter also referred to as additional storage processing) is described.

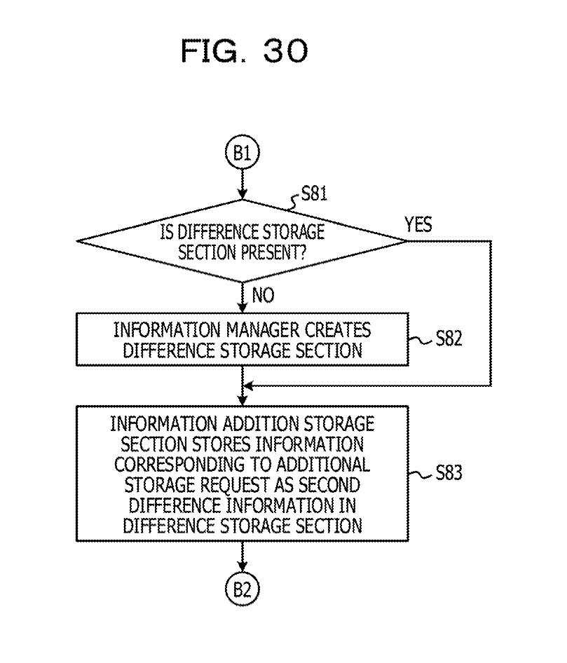

As illustrated in FIG. 29, when a processing request is allocated to the processing execution unit 121b, the processing execution unit 121b executes processing based on the allocated processing request. Then, if an additional storage request of new information has to be executed as a result of executing processing based on the processing request (NO at 572, NO at S77), the presence judgment unit 111 judges whether or not the difference storage section 130c is present, as illustrated in FIG. 30 (S81).

Then, if the difference storage section 130c is not present (NO at S81), an information manager 115 creates a difference storage section 130c (S82). On the other hand, if the difference storage section 130c is present (YES at S81), the information manager 115 does not execute the processing of S82.

Then, the information manager 115 stores information corresponding to the additional storage request as second difference information 135 in the difference storage section 130c (S83). The second difference information 135 is additional information to the stored information 131. Specifically, the second difference information 135 is, for example, information related to a row to be newly added to the stored information 131. A specific example of the second difference information 135 is described hereinafter.

FIG. 32 is a diagram illustrating a specific example of the second difference information 135. The second difference information 135 illustrated in FIG. 32 has an “Information ID” corresponding to the “Information ID” of the stored information 131 illustrated in FIG. 17 as an item. The second difference information 135 illustrated in FIG. 32 has “cancellation possibility” which is information indicating whether or not there is any possibility that an event identified by an “Event name” of the stored information 131 illustrated in FIG. 17 is canceled. More specifically, the second difference information 135 illustrated in FIG. 32 is information related to the “cancellation possibility” which is new information (row) to be added to the stored information 131 illustrated in FIG. 17.

Specifically, in the second difference information 135 illustrated in FIG. 32, “Yes” indicating that there is the possibility that the event is canceled is set as the “cancellation possibility” of information with the “Information ID” of “3” and “6”.

In addition, as illustrated in FIG. 32, the second difference information 135 has information (“Information ID”, for example) that uniquely identifies each piece of the information included in the stored information 131 to be merged. This allows the information merger 116 to associate each piece of the information included in the stored information 131 with each piece of the information included in the second difference information 135, and thus to merge the stored information 131 with the second difference information 135.

[Information Merge Processing]

Of the information control processing in the second embodiment, processing to merge information (hereinafter also referred to as information merge processing) is described hereinafter.

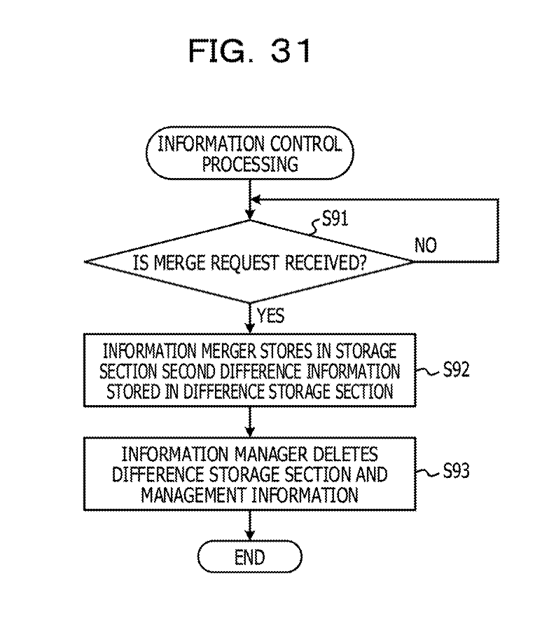

When receiving a merge request (YES at 591), the information merger 116 stores in the first storage section 130a the second difference information 135 stored in the difference storage section 130c as illustrated in FIG. 31 (S92). A specific example of the stored information 131 after the processing of S92 is executed is described hereinafter.

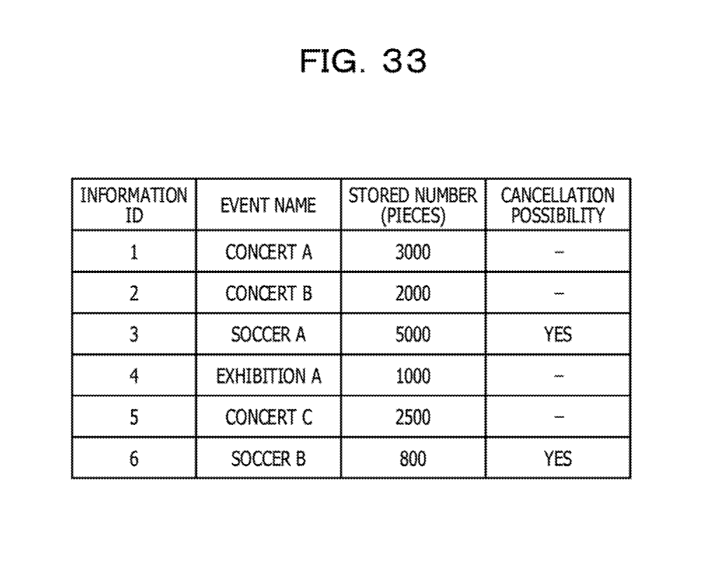

FIG. 33 is a diagram illustrating a specific example of the stored information 131 after the processing of S92 is executed. The stored information 131 illustrated in FIG. 33 has the “cancellation possibility” described in FIG. 32 as an item, in addition to the items included in the stored information 131 illustrated in FIG. 17 or the like.

Specifically, in the stored information 131 illustrated in FIG. 33, “Yes” is set for the “cancellation possibility” of information with the “Information ID” of “3” and “6”. In addition, in the stored information 131 illustrated in FIG. 33, a blank is set for the “cancellation possibility” of Information with the “Information ID” of “1”, “2”, “4”, and “5”.

More specifically, in an example illustrated in FIG. 33, the information merger 116 adds to the stored information 131 illustrated in FIG. 17 a row corresponding to the “cancellation possibility” of the second difference information 135 illustrated in FIG. 32. Then, as illustrated in FIG. 33, the information merger 116 sets information set for the “cancellation possibility” included in the second difference information 135 illustrated in FIG. 32. In addition, if the difference information 134 and the second difference information 135 are present in the difference storage section 130c, the information merger 116 may store the difference information 134 and the second difference information 135 in the stored information 131 stored in the first storage section 130a.

In this manner, the Information processor 1 in the second embodiment performs additional storage of new information by the information additional storage section 113, in addition to updating the difference information 134 by the information update unit 112 and reading information by the information reader 114. This allows the information processor 1 to limit the impact of the additional storage of the new information performed by the information additional storage unit 113 even when an unknown bug is included in a released program.

In addition, instead of having the stored number 131a as an item, the stored information 131 may have information about a number corresponding to a value indicated by the stored number 131a. A specific example of the stored information 131 having the information about the number corresponding to the value indicated by the stored number 131a is described hereinafter.

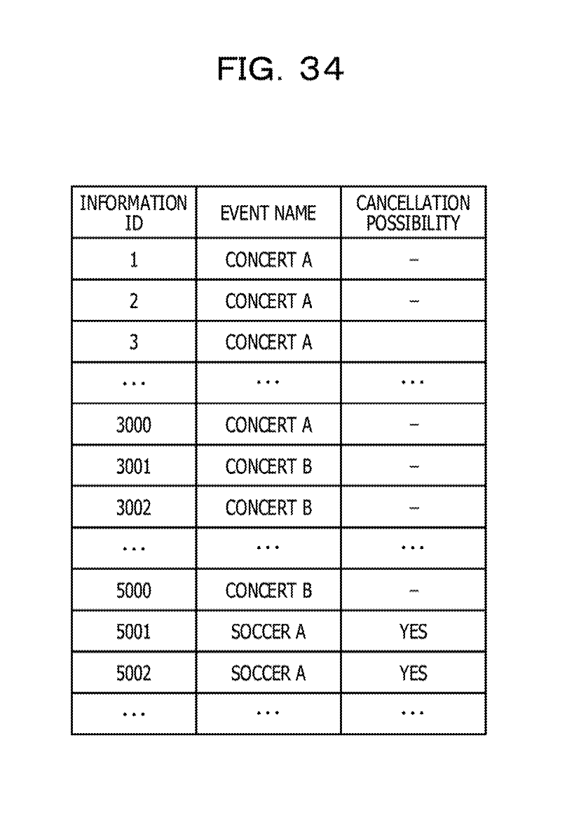

FIG. 34 is a diagram illustrating a specific example of the stored information 131 having information about a number corresponding to a value indicated by stored number 131a. The stored information 131 illustrated in FIG. 34 is different from the stored information 131 illustrated in FIG. 33 and does not have the “stored number” as an item. On the other hand, the stored information 131 illustrated in FIG. 34 has the pieces of Information (lines) the number of which corresponds to the value set for the “stored number” of the stored information 131 illustrated in FIG. 33.

Specifically, in the stored information 131 illustrated in FIG. 34, for each piece of information with the “Information ID” of “1” to “3000”, “Concert A” is set as an “Event name”, and a blank is set for the “cancellation possibility”. More specifically, the number of pieces of the Information with the “Event name” of “Concert A” in the stored information 131 illustrated in FIG. 34 corresponds to “3000”, which is the number set for the “stored number” of the information with the “Event name” of “Concert A” of the stored information 131 illustrated in FIG. 33. A description of other information of FIG. 34 is omitted.

This allows the information update unit 112 to transfer the stored information 131 stored in the first storage section 130a to the difference storage section 130c as difference information 134, by transferring the Information itself included in the stored information 131, rather than updating the stored number 131a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing an information control program that causes a computer to execute a process comprising:
receiving an update request for updating first information stored in a first storage area, the update request corresponding to a selected application; and
when the selected application is a first application having been available later than a second application that is configured to update the first information stored in a first storage area, updating second information based on the update request for updating the first information, the second information being information corresponding to a part of the first information and being stored in a second storage area different from the first storage area.

2. The non-transitory computer-readable storage medium according to claim 1, wherein the process further comprises:
in response to the receiving, determining whether or not the second storage area including the second information is present;
creating the second storage area and the second information stored in the second storage area when it has been determined, in the determining, that the second storage area is not present; and
storing the second information as the part of the first information in the first storage area, in response to receipt of a request to merge the second information with the first information.

3. The non-transitory computer-readable storage medium according to claim 2,
wherein, in the creating, management information is stored in the first storage area, the management information including information that the second information which is the part of the first information is transferred to the second storage area; and
wherein, in the storing the second information in the first storage area, the second information to be stored in the first storage area is identified by referring to the management information.

4. The non-transitory computer-readable storage medium according to claim 2,
wherein, the first information includes numeric value information; and
wherein, the update request is a request to change a value indicated by the second information.

5. The non-transitory computer-readable storage medium according to claim 4, wherein the process further comprises:
transferring a part of the first information that corresponds to a part of the numeric value information to the second storage area as a part of the second information when the value indicated by second information falls below a predetermined threshold.

6. The non-transitory computer-readable storage medium according to claim 2, wherein the process further comprises:
in the transferring the second information, in response to receipt of an additional storage request for storing specified information to the first storage section, determining whether or not the second storage area is present; and
creating the second storage area including the specified when it is determined that the second storage area is not present.

7. The non-transitory computer-readable storage medium according to claim 2, wherein the process further comprises:
before the transferring the second information, in response to the receipt of the update request, determining whether the update request corresponds to the first application or the second application;
when the update request corresponding to the first application, performing the transferring the second information and the updating the second information; and
when the update request corresponding to the second application, updating the first information based on the update request instead of performing the transferring the second information and the updating the second information.

8. An information controller comprising:
a memory;
and a processor, coupled to the memory, configured to:
receive an update request for updating first information stored in a first storage area, the update request corresponding to a selected application; and
when the selected application is a first application having been available later than a second application that is configured to update the first information stored in a first storage area, update second information based on the update request for updating the first information, the second information being information corresponding to a part of the first information and being stored in a second storage area different from the first storage area.

9. An information control method comprising:
receiving an update request for updating first information stored in a first storage area, the update request corresponding to a selected application; and
when the selected application is a first application having been available later than a second application that is configured to update the first information stored in a first storage area, updating second information based on the update request for updating the first information, the second information being information corresponding to a part of the first information and being stored in a second storage area different from the first storage area.
